(19) United States
(12) Patent Application Publication
(10) Pub. No.: US 2007/0246320 A1
(43) Pub. Date: Oct. 25, 2007

(54) Synchronizing device for manual transmission

(76) Inventor: Young Chan Youk, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/589,481

(22) Filed: Oct. 30, 2006

(30) Foreign Application Priority Data
Apr. 20, 2006 (KR) 10-2006-0035849

(51) Int. Cl. F16D 11/00

(52) U.S. Cl. 192/53.34; 192/53.32

(57) ABSTRACT

A synchronizing device of a manual transmission for synchronizing rotation speeds of a rotating shaft and a shift gear includes a gear clutch that rotates with the shift gear and a synchronizer assembly. The synchronizer assembly includes a synchronizer ring; at least one first ring, having a slanted surface, between the synchronizer ring and the gear clutch; and at least one second ring with a slanted surface that contacts the slanted surface of the first ring.

### CROSS-REFERENCE TO RELATED APPLICATION

This application claims priority to and the benefit of Korean Patent Application No. 10-2006-0035849 filed in the Korean Intellectual Property Office on Apr. 20, 2006, the entire contents of which are incorporated herein by reference.

### BACKGROUND OF THE INVENTION

(a) Field of the Invention

The present invention relates to a manual transmission. More particularly, the present invention relates to a synchronizing device of a manual transmission.

(b) Description of the Related Art

Generally, a manual transmission includes a plurality of gears disposed on a rotating shaft. A required shift speed is attained by synchronizing rotating speeds of the rotating shaft and the gears. The transmission also includes a synchronizer mechanism for synchronizing the rotation speeds of the rotating shaft and the gears.

A typical synchronizer mechanism has a very complicated scheme including a synchronizer ring of a gear scheme. In addition, the synchronizer mechanism is large, and therefore the transmission is large.

As engine performance is improved, larger capacity synchronizer systems are required.

Larger capacity synchronizer systems include a triple cone having three friction surfaces. However, due to space limitations, synchronizer systems with larger capacities than the triple-cone type have not traditionally been used.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a synchronizing device of a manual transmission with a large capacity.

An exemplary embodiment of the present invention provides a synchronizing device of a manual transmission that synchronizes rotation speeds of a rotating shaft and a shift gear. The device includes a gear clutch integrally rotating with the shift gear and a synchronizer assembly that synchronizes the rotation speeds of the rotating shaft and the shift gear. The synchronizer assembly includes a synchronizer ring, at least one first ring disposed between the synchronizer ring and the gear clutch and forming a slanted exterior surface, and at least one second ring with an interior surface contacting the exterior surface of the first ring.

The at least one second ring may include a gap at a predetermined position. The at least one first ring and the at least one second ring may both be pluralities of rings. One or more of the first rings may be movable in an axial direction of the rotating shaft. A first protruding portion to support the first ring that is closest to the shift gear may be formed on an exterior circumference of the gear clutch, and a second protruding portion to prevent slip-out of the second ring that is farthest from the shift gear may be formed on interior circumferences of the gear clutch and the synchronizer ring. Cross-sections of the first ring and second rings may be right triangles.

### BRIEF DESCRIPTION OF THE DRAWINGS

FIG. 1 is a cross-sectional view showing a synchronizing device of a manual transmission according to an exemplary embodiment of the present invention;

FIG. 2 is a perspective view showing a combination of rings according to an exemplary embodiment of the present invention; and

FIG. 3 is an enlarged view of portion A of FIG. 1.

### DETAILED DESCRIPTION OF THE PREFERRED EMBODIMENTS

An exemplary embodiment of the present invention will hereinafter be described in detail with reference to the accompanying drawings.

As used herein, the term “manual transmission” should be understood as any transmission with a plurality of gears disposed on a rotating shaft in which rotating speeds of the rotating shaft and the gears are synchronized.

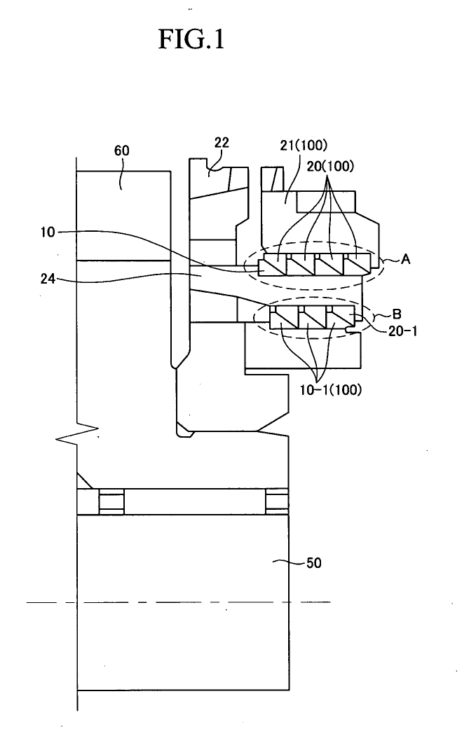

As shown in FIG. 1, according to an exemplary embodiment of the present invention, a synchronizing device of a manual transmission, which synchronizes the rotation speeds of a rotating shaft 50 and a shift gear 60, includes a gear clutch 22 and a synchronizer assembly 100.

The gear clutch 22 integrally rotates with the shift gear 60. The synchronizer assembly 100 synchronizes the rotation speeds of the rotating shaft 50 and the shift gear 60.

The synchronizer assembly 100 includes a synchronizer ring 21, at least one first ring 10, and at least one second ring 20.

Each first ring 10 is disposed between the synchronizer ring 21 and the gear clutch 22 and has a slanted exterior surface. Each second ring 20 has a slanted interior surface contacting the slanted exterior surface of a respective one of the first rings 10.

When a driver operates a shift lever (not shown), a control system (not shown) operates and a sleeve (not shown) connected to the synchronizer assembly 100 integrally rotates with a hub gear (not shown) connected to the rotating shaft 50.

The shift lever, the sleeve, and the hub gear may be designed by a person of ordinary skill in the art based on the teachings herein. The control system may include a processor, memory, and associated hardware, software, and/or firmware as may be selected and programmed by a person of ordinary skill in the art based on the teachings herein.

The synchronizer ring 21 is movably disposed to the hub gear such that if the sleeve moves, the synchronizer ring 21 moves.

The gear clutch 22 includes a cone portion 24 that integrally rotates with the gear clutch 22.

As shown in FIG. 1, according to an exemplary embodiment of the present invention, the first ring 10 and the second ring 20 are disposed between the synchronizer ring 21 and the cone portion 24.

The synchronizing device may further include a second set of at least one first ring 10-1 and at least one second ring 20-1 disposed between a lower portion of the cone portion 24 and the gear clutch 22. The at least one first ring 10 may be disposed to an exterior circumference of the cone portion 24 and the at least one second ring 20 may be disposed to an interior circumference of the synchronizer ring 21.

Cross-sections of the first rings 10 and second rings 20 may be right triangles.

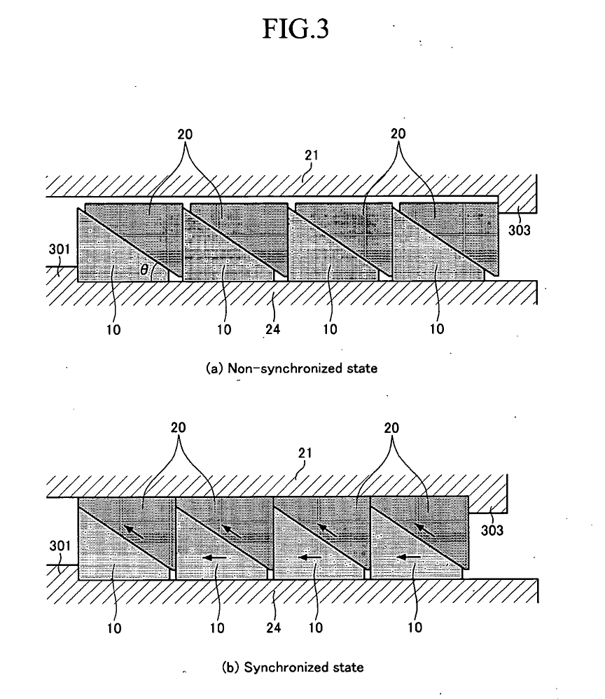

FIG. 3 shows a synchronizing operation of a rotating shaft and a gear on the rotating shaft of a synchronizing device of a manual transmission and is an enlarged view of a portion A in FIG. 1. Portion B of FIG. 1 can be understood by a person of ordinary skill in the art based on FIG. 3 (Portion A), and therefore, only portion A is explained herein.

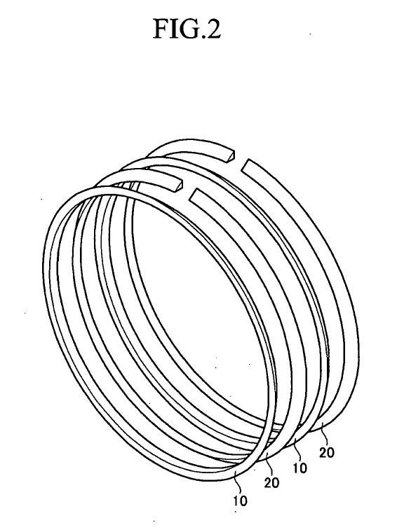

Referring to FIG. 2, second rings 20 include gaps at a predetermined position. Therefore, referring to FIG. 3, when a force in an axial direction acts on the second ring 20, the second ring 20 slides along the slanted exterior surface of the first ring 10, widening the gap and enlarging the radius of the second ring 20.

One or more of the first rings 10 may be movable in an axial direction of the rotating shaft 50.

Referring to FIG. 3, a protruding portion 301 to support the first ring 10 that is disposed to the shift gear side of the plurality of first rings 10 may be formed on an exterior circumference of the gear clutch 22. The protruding portion 301 may be disposed on the cone portion 24.

A protruding portion 303 to prevent slip-out of the second ring 20 that is disposed farthest from the shift gear may be formed on an interior circumference of the gear clutch 22 and the synchronizer ring 21.

Therefore, in a case that the protruding portion 303 is forced toward the second ring 20 in the axial direction by movement of the synchronizer ring 21, frictional force is generated between the slanted exterior surface of the first ring 10 and the slanted interior surface of the second ring 20. In addition, a frictional force is generated by the first ring 10 and the second ring 20 contacting the synchronizer ring 21 and the cone portion 24. Synchronization of the transmission is achieved by the frictional forces.

According to an exemplary embodiment of the present invention, four first rings 10 and four second rings 20 are mounted in the A portion and three of each are mounted in the B portion, respectively. However, the number of first rings 10 and second rings 20 can be changed to correspond to various engines of vehicles.

Referring to FIG. 3(a), in an exemplary embodiment of the present invention, an angle θ between the first ring 10 and an exterior circumference of the rotating shaft 50 is 45 degrees. However, the present invention is not limited to this angle. If the angle θ is small, axial direction movements of the first and second rings 10 and 20 are large, but a large synchronizing engagement force can be obtained by a small axial direction force, and if the slanted angle θ is large, the opposite effect is obtained. Therefore, an appropriate angle θ can be chosen based on engine torque of the transmission for which the present invention is used. That is, the basic scheme of the transmission can be identical, and only first and second rings 10 and 20 need be changed for various engines.

Exemplary embodiments of the present invention provide a synchronizing device that can be used with various vehicles. In addition, the synchronizing device occupies a small space and has a large capacity.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A synchronizing device of a manual transmission for synchronizing rotation speeds of a rotating shaft and a shift gear, comprising:
a gear clutch that rotates with the shift gear; and
a synchronizer assembly comprising:
a synchronizer ring;
at least one first ring disposed between the synchronizer ring and the gear clutch and comprising a slanted surface; and
at least one second ring comprising a slanted surface contacting the first ring slanted surface.

2. The device of claim 1, wherein the at least one second ring comprises a gap.

3. The device of claim 1, wherein the at least one first ring comprises a plurality of first rings and the at least one second ring comprises a plurality of second rings.

4. The device of claim 1, wherein one or more of the at least one first ring is movable in an axial direction of the rotating shaft.

5. The device of claim 1, wherein the gear clutch comprises a protruding portion adjacent one of the at least one first ring.

6. The device of claim 1, wherein the gear clutch comprises a protruding portion adjacent one of the at least one second ring.

7. The device of claim 1, wherein the synchronizer ring comprises a protruding portion adjacent one of the at least one second ring.

8. The device of claim 1, wherein the at least one first ring comprises a substantially triangular cross-section.

9. The device of claim 8, wherein the at least one first ring comprises a substantially right-triangular cross-section.

10. The device of claim 1, wherein the at least one second ring comprises a substantially triangular cross-section.

11. The device of claim 10, wherein the at least one second ring comprises a substantially right-triangular cross-section.
